(19) United States
(12) Patent Application Publication
(10) Pub. No.: US 2010/0287525 A1
(43) Pub. Date: Nov. 11, 2010

(54) EXTENSION THROUGH VISUAL REFLECTION

(75) Inventor: Timothy A. Wagner, Seattle, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/436,808

(22) Filed: May 7, 2009

(51) Int. Cl. G06F 9/44

(52) U.S. Cl. 717/100

(57) ABSTRACT

An integrated development environment (IDE) can be extended through reflection. Discovery and initiation of extension can be performed from within the IDE using elements of the IDE rather than using a separate software development kit (SDK). User interface (UI) elements available to a user provide the extension points in an intuitive fashion without searching, browsing or complex documentation. Context sensitive options can be provided because the context is available from the point of user interaction.

### BACKGROUND

An integrated development environment (IDE) is a software application that provides comprehensive facilities for developers of software. An IDE normally includes at least a source code editor, a compiler and/or an interpreter, build automation tools and a debugger. A version control system and various other tools may also be integrated into the IDE to simplify the software development process. Some IDEs also have a class browser, an object inspector, and a class hierarchy diagram for use with object-oriented software development. Typically an IDE is dedicated to a specific programming language so that a set of features that match the programming paradigms of the language can be provided. However, some multiple-language IDEs are known, such as Eclipse, ActiveState Komodo, recent versions of NetBeans, Microsoft Visual Studio and WinDev.

An IDE typically presents a single environment in which all development occurs and provides a number of features for authoring, modifying, compiling, deploying and debugging software. The aim of the IDE is to increase programmer productivity. Some IDEs are graphical, while others are text-based and use function keys or hotkeys to perform various tasks. Software development can also be performed outside an IDE, using unrelated tools, such as vi, GCC or make.

Some IDEs are extensible, meaning that end user tools are provided to allow the end user to add their own or third party functionality to the IDE. Extending an IDE is often a complex operation that involves installing and learning how to use an additional software development kit or SDK. A software development kit or “devkit” typically includes a set of development tools that allows a developer to create applications for a certain software package, software framework, hardware platform, computer system, video game console, operating system, or other platform. An SDK can be simply an application programming interface (API) in the form of some files to interface to a particular programming language or can include more sophisticated features. SDKs may include technical notes or other supporting documentation to help clarify points from the reference material provided by the IDE. Learning how to use an SDK can be a significant task and can involve acquiring detailed knowledge of APIs, testing environments and operational logistics of naming, security and so on.

From the end user's point of view, learning how to use an SDK is expensive, but from the standpoint of an IDE provider or third party provider of IDE extensions, SDKs are also expensive. The SDK provider has to devote development resources to create and maintain the SDK samples and the software that manipulates the samples across the different releases of the target IDE.

### SUMMARY

An integrated development environment (IDE) is extended through visual reflection. Discovery of extension capabilities and subsequent extension of the IDE is initiated within the IDE rather than using a separate software development kit (SDK), browser, search box, or documentation/help system. User interface (UI) elements visible or available to a user provide extension points in an intuitive fashion without searching, browsing or complex documentation. Because the extension points are located within the IDE itself, rather than from an installed SDK, more context is available and can be associated with context-specific information that may decrease the customization expense of defining a new extension.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings:

FIG. 1 is a block diagram of an example of a system for extension through visual reflection in accordance with aspects of the subject matter disclosed herein;

FIG. 2a is a flow diagram of an example of a method for extension through visual reflection in accordance with aspects of the subject matter disclosed herein;

FIG. 2b is an example of a user interface for extension through visual reflection in accordance with aspects of the subject matter disclosed herein;

FIG. 3 is a block diagram illustrating an example of a computing environment in which aspects of the subject matter disclosed herein may be implemented; and

FIG. 4 is a block diagram of an example of an integrated development environment in accordance with aspects of the subject matter disclosed herein.

### DETAILED DESCRIPTION

### Overview

SDKs may include sample code and a “sample browser” that enables the user to pick from an established set of samples by which an IDE can be extended. Samples are usually not customizable except by the post hoc addition or modification of their source. Document search and browsing can also lead the user to examples or sample code. “Copy and paste”-style extension is also sometimes available. These methods are often accompanied by a steep learning curve for the end user. For example, consider the case in which an IDE is extensible via samples provided in an SDK. To extend the IDE, first the user has to know that the IDE is extensible. Then he or she has to know that there is an SDK available, has to install the SDK, has to discover that samples are accessible via a sample browser, has to run the sample browser, has to find the sample that is the closest to what the user wants to do and then has to code the desired modifications to the sample. Even experienced SDK users often have to go through a learning process, as for example, when a new release of an IDE incorporates new features that are reflected in a corresponding SDK.

The subject matter described herein is directed to lowering the barrier for first-time users who want to extend an IDE and also for increasing the productivity of experienced or professional users by using the IDE's own UI as a launch point, conceptually adding one or more “extend this” actions to a number of UI elements. Because extensibility usually involves something a user can see or do, the existing elements in an IDE are a convenient and easily discoverable entry point into the extensibility process. Because the initiating user action is associated with some context for the type of UI or activity being extended, corresponding context-sensitive options and information can be offered and can be used to customize the extension.

It will be appreciated that the “visual” nature of the starting point need not be an active window. The extensibility starting point could for example be an active window, such as a tool window, a portion of an active window, such as an editor margin, a conventional proxy for a non-active, hidden, or yet-to-be-constructed UI element. Such elements include but are not limited to a menu or toolbar element which constructs, displays, unhides, or makes such a window or UI element active, a proxy for the window or UI element, including a name in a dropdown list, such as an overflow list, the name of the window or element in a tab, a sidebar, or any other proxy for the item when the item is in an inactive, hidden, or yet-to-constructed state, an area typically associated with a specific window or UI element, even if the window or UI element is not (yet) present, such as the central area of an IDE, which may be left blank if/when the editor is not shown, or representations of the window or UI element in a visual explorer, list of windows or UI elements, registry, persisted layout file, or any other representation or proxy for windows or UI elements that may be maintained by an IDE or related tool, whether in memory, on disk, or in the state of another (potentially 3rd party) program or application.

The motivation for providing context sensitive help is to provide the user with a simple, obvious and intuitive way of identifying the item of interest simply by pointing to it. The use of the existing visible or UI elements within the IDE presents the user with a “palette” of known examples by which he can choose the one most representative of the eventual extension he wishes to create. In preference to a single, canned sample, this permits the immediate customization of the extension being created by seeding it with the settings (visual or otherwise) of the UI element from which the customization action was initiated. The activity (context) in which the user was engaged can also form part of the input to the creation of the new UI element—for instance, it will be well known to an IDE if the user is working in a C# file when he attempts to create a new margin for the editor, and the IDE may therefore reasonably guess that the user would like the experience of creating the code for the new margin to be done in C# as opposed to some other programming language. The combination of the user's workflow and activities and the specific UI element chosen as the starting point are, in combination, a much richer source of information for customizing the resulting experience of creating or modifying the new extension, whether it be done via a wizard or via a more conventional development experience.

Consider an example where the user wishes to create a new margin for a text editor. The workflow can proceed as follows: the user launches the IDE, if it is not already running, and brings up a file to be edited. The user can then right click on any existing margin. The options that appear can include an option for “Create a new margin”. The user can then select the option, “Create a new margin”. A corresponding wizard for creating a new margin can appear and can offer the user variations such as but not limited to: does the user want to create a new margin? does the user want to create a new item to be included in the existing margin he or she clicked on? and so on. After receiving a user response answering those questions or selecting the appropriate options, the IDE extender module of the IDE can create a new margin component and either add it to the running version of the program or (at the discretion of the user or at the discretion of the IDE) can launch an experimental or test version of the IDE with the new margin component included. The new margin being created could “preset” its placement (top, bottom, left, right), background color, default font, etc. to those same settings on the margin from which the extension activity was initiated. The user can then begin adding or editing the functionality of his/her new margin to customize it programmatically or, in some cases, declaratively. Standard language and component techniques can be employed to make writing this extension and adding it to the IDE as easy as possible, but those techniques themselves are orthogonal to their initiation, as described here. Extension of the IDE may be augmented for novice extenders with additional user actions that can be used to customize or place the result—for example, a “drag and drop” maneuver can move the margin to the top, bottom, left, or right of the display, order it with respect to other (existing) margins, etc. As another example of this post hoc or in-lined customization, menu items can be dragged to their intended menu.

The connection between visual elements and the appropriate component, interface or superclass is a reflection-like activity than can proceed in various ways. UI automation techniques can map cursor location to underlying form elements and via reflection can map cursor location to classes serving as data providers to the form elements. Explicit mappings can be created and maintained. However it is accomplished, this “back-mapping” from a visual artifact to a provider of it (or subclass or implementation thereof) can be unique or the user can be apprised of the options available to allow the user to disambiguate the selection. Managed code, managed UI/presentation layers (such as Microsoft's Windows Presentation Foundation, and component technologies such as MEF or OSGI enable this process to be more automated and require less manual work to establish and/or maintain but other well-known techniques including Java Swing and Eclipse SWT can also be employed for this purpose. MEF (Managed Extensibility Framework) is a library in .NET that permits greater reuse of applications and components by permitting applications to be dynamically composed rather than being statically compiled. Native solutions also can be back-mapped by, for example, providing metadata linking the provider class or classes with their expression in some UI of the product.

### Extension Through Visual Reflection

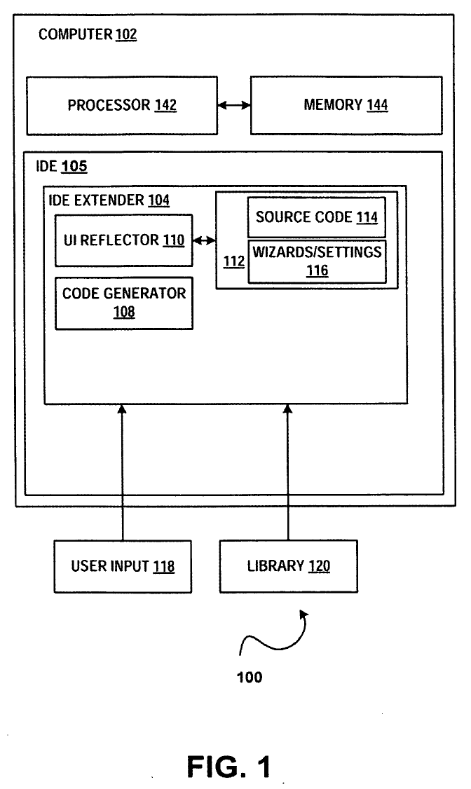

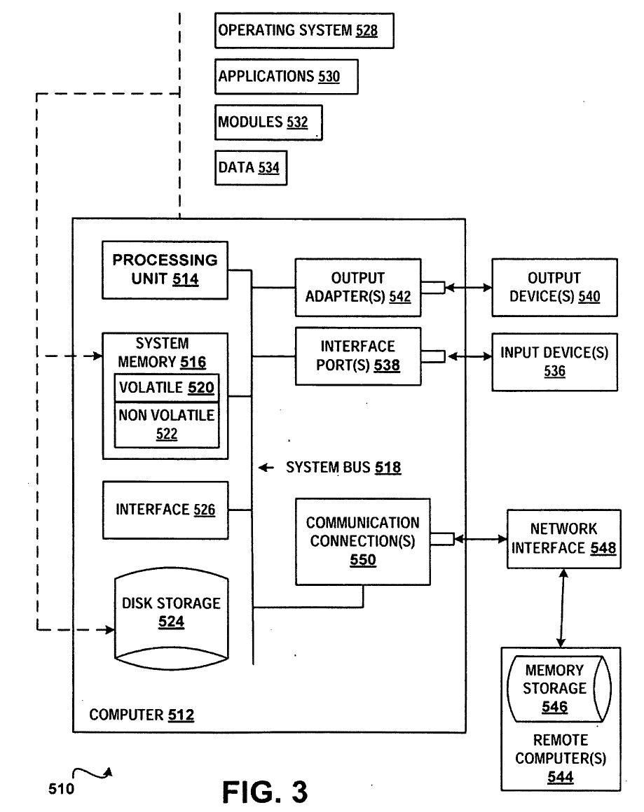

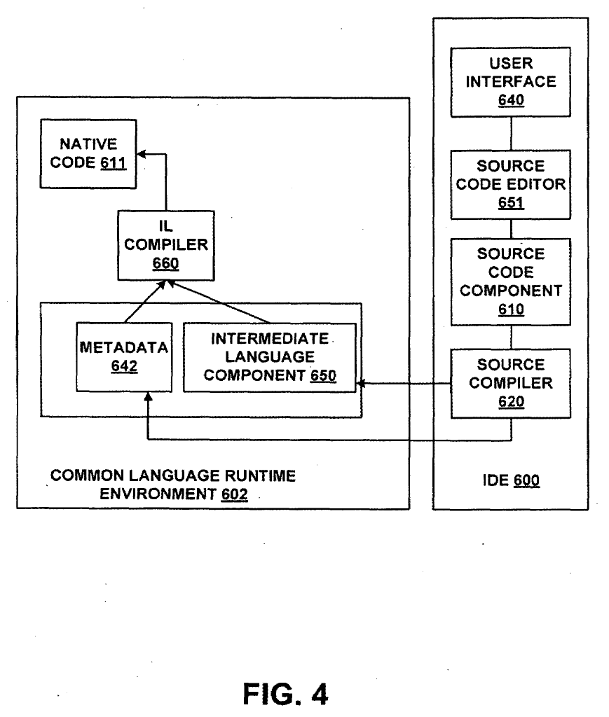

FIG. 1 illustrates an example of a system 100 that extends an IDE 105 using visual reflection in accordance with aspects of the subject matter disclosed herein. All or portions of system 100 may reside on one or more computers such as the computers described below with respect to FIG. 3. All or portions of system 100 may reside on one or more software development computers (e.g., computer 102) such as the computers described below with respect to FIG. 4. The system 100 or portions thereof can comprise or comprise a portion of an integrated development environment (IDE) such as the ones described and illustrated below with respect to FIG. 4 or can be a standalone system or a plug-in.

System 100 may include one or more processors (such as processor 142) that executes program modules, a memory 144 into which one or more program modules and data can be loaded, and an IDE 105 of which IDE extender 104 (also referred to herein as an IDE extension module) is a part. An IDE extender 104 can comprise an IDE extension code generator 108, a UI reflector 110 and a library of IDE extensions 112. An IDE extender 104 can be an original part of the IDE as it is shipped to a customer instead of a part of a separate SDK package. Inputs to IDE extender 104 can include user input 118 and a library 120. User input 118 may include user selections and responses as described above.

Library 120 can include source code and is not limited to places where the base class or implementation is available via source. Source code includes code added by the user in any number of ways: through writing new compiled or interpreted code, by using a visual designer or other tool which creates the code, by selecting from a list of predefined (“canned”) routines, etc. The IDE itself will typically provide a mechanism by which the user is afforded any of the conventional means of creating, modifying, extending, designing, or selecting the mechanisms and appearance of the new window or UI element being added or modified. The mechanisms for extension and creation are well known and are merely used here by reference, but could include subclassing of base classes, the use of interfaces or other APIs, the use of compiled or interpreted code to access extensibility points, the use of declarative mechanisms such as XAML or OSGI to create or utilize extensibility points or interact with existing graphical subsystems, and so forth.

Library 120 can include data templates comprising elements of the IDE 105 including but not limited to one of more of: a tool window, an editor window, menu or command bar items, or items listed in a right context menu. Within an editor, an element may include one or more of: an adornment, a margin, a classification, an item in a right context menu, context-sensitive intelligent help, parameter help or quick help.

An adornment is a visual element (such as a UI control, a picture, a two dimensional or three dimensional drawing, a text box, a media player, or any other visual or interactive element, such as a Windows Presentation UI Element or a Java Swing or Eclipse SWT visual element) which is associated with either a region of text or an area of the screen. The adornment may be placed above, below, or inside the text, and it may have a fixed relationship to either the text or the screen or can be allowed to “float” (to be repositioned) based on one or more rules such as, but not limited to, scrolling, pagination, the content of the text, user settings, etc. The presence of an adornment may interact with the layout rules of the text, causing (for example) additional vertical space between lines of text to accommodate the height of the adornment and/or additional horizontal space between characters within a line to accommodate the width of the adornment. Samples of adornments may include: debugger breakpoints, WYSIWYG (What You See Is What You Get) comments that display HTML, embedded documentation comprised of readers for manual pages, training videos linked to ideas or concepts present in the text, “popups”, and other visual representations.

A classification is a mapping from spans of text to font- or other text display- to specific attributes of that span. Classification may be used to generate conventional syntax highlighting via lexical rules that map from programming language tokens to color settings. It can also be used to create “fisheye” or magnifying viewers that expand the size or family of font used near where the user is currently reading or where the cursor appears. Classifications can aggregate; that is, multiple classifications can be used at once with their resulting settings merged together. An example is a conventional programming language syntax highlighter for C++, coupled with a classifier which dims (reduces the alpha channel or opacity control) for areas of the file which have been # defined out. The result is a diminished visual representation for those areas without any loss of information content with respect to their lexical structure.

The mechanism by which extensibility in the IDE is implemented encompasses options including compiled or interpreted code, can be initiated via interfaces, superclasses, COM, etc., can be present in binary and/or source form, and can be declarative or visual. That is, all the usual language and IDE mechanisms for extensibility by code, design, or other forms of customization can be applied. The user can exploit one or more of the proffered extensibility mechanisms to add new (or modify existing) code or add new (or modify existing) declarative specifications using known mechanisms, typically those offered by the IDE itself for similar purposes. All the usual language and IDE mechanisms, including source code editors in various languages, interpreters and compilers, wizards, visual designers, XML/XAML and other declarative editing experiences, etc. can be employed for the purpose of extensibility. The newly created (or modified) extension can be stored in a library of extensions. This library can be a code library, a data library (for declarative specifications), can be made part of the original IDE or can be kept separate, etc.

In accordance with some aspects of the subject matter disclosed herein, a UI reflector 110 can perform the back-mapping or reflection from the UI of the IDE to context-specific code. The UI reflector 110 can receive the user input and from the context in which the user input is received, determine a corresponding wizard for the context and user selection and a set of default settings for the element to be added or modified. Similarly, the UI reflector 110 can retrieve the corresponding source code when source code is provided to the user for creation of a new element or for modification of an existing element in the IDE. An IDE extension code generator 108 can compile and/or build the user-modified source code to generate an executable. The new source code can be stored in the library of IDE extensions 112. The library of IDE extensions 112 can be integrated into the library 120 that is an input to the IDE extender 104 or may be maintained separately from library 120. The library of IDE extensions 112 may include wizards and settings 116 and source code 114 for IDE extension elements.

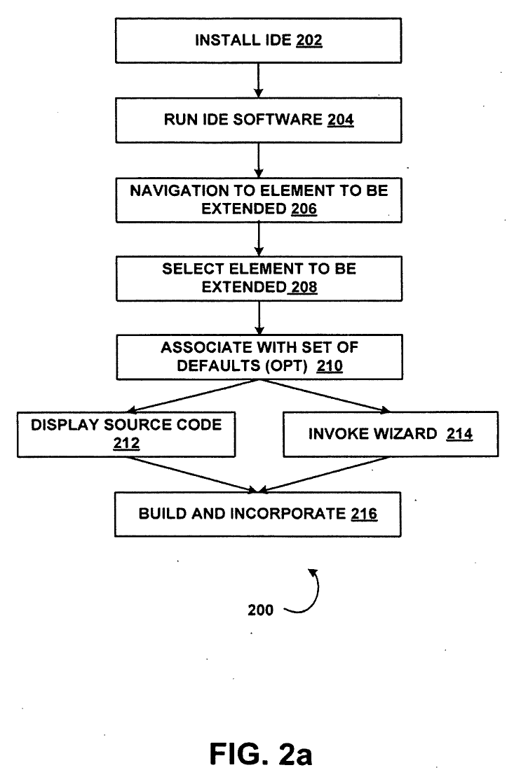

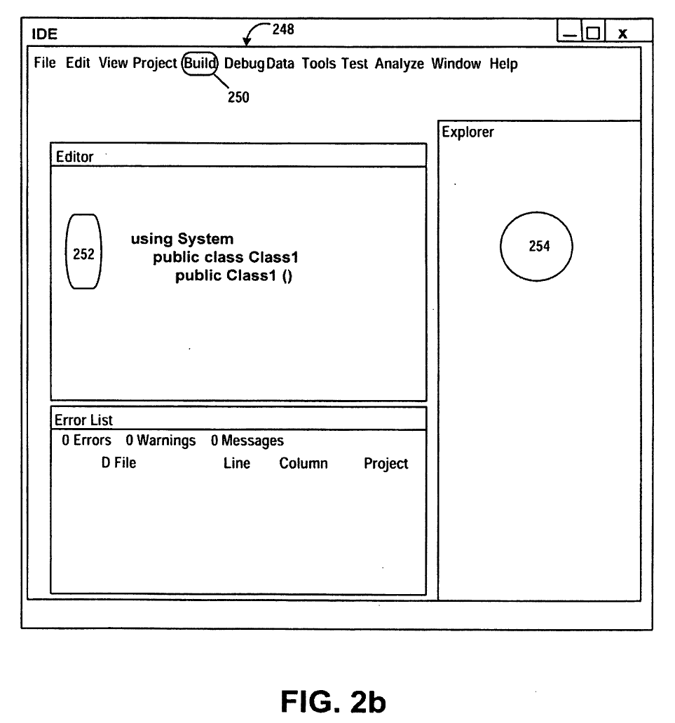

FIG. 2a illustrates a method 200 of extending an IDE by visual reflection in accordance with aspects of the subject matter disclosed herein. At 202 an IDE can be installed. In accordance with aspects of the subject matter disclosed herein, no SDK or developer's kit (devkit) has to be installed to extend the IDE. At 204 the IDE software can be executed. At 206 a user may navigate to a particular section of the IDE that the user wants to extend. Typical extensions to an IDE include adding another one of something or modifying an existing thing. In this case, the user may navigate to a UI provided by the IDE, where the UI displays an element that the user would like another one of or would like to modify. Examples include a command button, a menu item, a tool window, a piece of an editor such as a margin such as a line number margin or error margin, a scroll bar, an adornment and so on. At 208, the user may select the item, thereby commencing an interaction with the UI. During the interaction, the user may identify the item to be duplicated or modified by a user action or series of user actions. An example of one possible interaction may be selecting the item and performing a right-click operation. In additional to existing options provided in the right-click menu, a new option or options might include “create a new one using this one as a template” or “modify this one”.

The identification of the UI element or window to be extended (or to otherwise initiate the extension or customization activity) can be by any of the usual means for identifying a portion of the UI, including but not limited to: left or right clicking on the visible area of the element in question; left or right clicking on a proxy for the item in question, such as tabs, bars, icons, or other places where a name, title, or representation of the item appears in the IDE; selection from a list or hierarchy related to the UI element in question, such as a registry, persisted representation of the UI layout, list of windows in a dropdown or menu, hierarchy of UI elements as presented by the IDE itself or via a 3rd party application or tool for exploring UIs, representation of the UI in source or designer form, such as a XAML file or a visual proxy for the IDE's UI, use of “lassos” or other well-known mechanisms for identifying a portion of the screen, or other similar mechanisms for selecting or identifying a UI element or window. The user may also have ways of identifying the window or UI element by selecting a proxy for it, such as the name of a command which invokes the window or UI element or causes it to become active or visible.

This approach to IDE extension can transform an element in the IDE into a sample and eliminates having to provide a separate SDK, samples and sample browser in order to extend the IDE. Referring now to FIG. 2b, an example of a UI 248 by which such a feature can be provided is illustrated. Areas such as those indicated by the circles identified by reference numerals 250, 252 and 254 are areas that are examples of areas on the UI screen where additional right-click options can be provided. It will be appreciated that the areas shown are meant to be illustrative, non-limiting examples. Moreover, it will be appreciated that the access to extensibility is not limited to a right-click operation. The extensibility feature can be accessed via any well-known programming technique including but not limited to some keystroke or series of keystrokes, by navigation to an extension menu, initiation of a development tool and so on.

The options provided upon triggering the extensibility feature can be customized to the type of element selected for extension. For example if a user selected the area identified by reference numeral 254, the option or options provided can be to build another tool window or to modify the selected tool window. If the area on UI 248 identified by reference numeral 252 were selected, the option or options provided can be to build or modify an editor margin. If the area identified by reference numeral 250 were selected, the option or options provided can be to add or modify a command and so on. Selection of an area or element in the IDE to extend can associate the new or modified item to be associated with a set of defaults at 210, if appropriate.

The selected element may be used as a template to establish the same settings (defaults) as the selected element for the extension element. The newly constructed extension element settings may include stylistic issues, occurrences of items of interest to the user, or something else which requires a similar visual treatment for these settings but is not otherwise associated with the selected element. For example, tool windows in a particular IDE may be typically located on the right hand side of the display and take up the full height of the display. Hence creation of a new or modified tool window can be automatically set to default settings associated with the selected tool window template that place the new or modified tool window on the right hand side of the full height of the display. Similarly, editor margins in a particular IDE may be associated with a particular background color. Hence, creation of a new or modified editor margin element can be automatically set to default settings of that background color. Likewise, error lists may typically use half the height of the display, have a tabular format and are located at the bottom of the display, hence creation of a new error list may be associated with default settings that place the new error list at the bottom of a display, with a tabular format and a half height display, and so on. Automatic association of a set of default settings is possible because more context is known because the item selected for extension exists in a particular context within the IDE and has been chosen by the user versus other instances to best represent the settings or characteristics for the extension element.

At this point, either the source code can be displayed at 212 or a wizard can be invoked at 214. If the source code is displayed, the source code could be displayed within an editor for modification by the user. If a wizard is invoked, the user can be prompted for input concerning customization choices such as, for example, choices that affect the appearance and behavior of the element comprising the IDE extension. The IDE itself can provide the editing, design or customization experience instead of limiting the customization experience to source code editing.

In additional to adding new elements as described above, (e.g., add a new tool window) the IDE extension feature described herein can permit the modification of an existing element. For example, a new contribution can be added to an existing element. For example, a new data contributor may be added to an existing element. For example, a new visual contribution may be added to an existing element. Illustrative non-limiting examples of modifications to existing elements are a “per line” or “global to file” margin in the editor. Additional illustrative non-limiting examples include Intellisense, parameter and quick help, smart tags, etc.

An existing element can also be modified by continuing to develop and customize an extension created earlier or one provided by the IDE itself or an element provided by a third party. In the latter case the extension feature can also serve as a quick way of “indexing” the extension library. Modification of an existing element may involve adding additional data sources to an aggregating element. For example, a right margin area of an editor may display global information such as line information for searches, errors, warnings, changes made by one or more users. An extension to an aggregating element such as an editor margin may comprise adding an additional information provider to the element. For example, a modification to an existing editor right margin can be to add additional information from a data provider that provides source locations of a term of interest, coding or stylistic constraint violations, adornments of a particular type or content, or other locations in the code, text, or adornments of interest to this extension.

It will be appreciated that modifications to aggregating elements are not limited to adding data providers. For example, a modification to an existing aggregating element could change the appearance of an existing visual element and so on. At 216 in response to receive user input to create the new or modified element, the IDE extension code generator is invoked to build the new element and incorporate it into the IDE, as described above. The new element can be stored in an IDE extension library. The IDE can create the new element and either add it to the running version of the program or can launch an experimental version of the IDE (a test instance of the IDE) with the IDE element included.

### Example of a Suitable Computing Environment

In order to provide context for various aspects of the subject matter disclosed herein, FIG. 3 and the following discussion are intended to provide a brief general description of a suitable computing environment 510 in which various embodiments may be implemented. While the subject matter disclosed herein is described in the general context of computer-executable instructions, such as program modules, executed by one or more computers or other computing devices, those skilled in the art will recognize that portions of the subject matter disclosed herein can also be implemented in combination with other program modules and/or a combination of hardware and software. Generally, program modules include routines, programs, objects, physical artifacts, data structures, etc. that perform particular tasks or implement particular data types. Typically, the functionality of the program modules may be combined or distributed as desired in various embodiments. The computing environment 510 is only one example of a suitable operating environment and is not intended to limit the scope of use or functionality of the subject matter disclosed herein.

With reference to FIG. 3, a computing device for extending an IDE via visual reflection in the form of a computer 512 is described. Computer 512 may include a processing unit 514, a system memory 516, and a system bus 518. The processing unit 514 can be any of various available processors. Dual microprocessors and other multiprocessor architectures also can be employed as the processing unit 514. The system memory 516 may include volatile memory 520 and nonvolatile memory 522. Nonvolatile memory 522 can include read only memory (ROM), programmable ROM (PROM), electrically programmable ROM (EPROM) or flash memory. Volatile memory 520 may include random access memory (RAM) which may act as external cache memory. The system bus 518 couples system physical artifacts including the system memory 516 to the processing unit 514. The system bus 518 can be any of several types including a memory bus, memory controller, peripheral bus, external bus, or local bus and may use any variety of available bus architectures.

Computer 512 typically includes a variety of computer readable media such as volatile and nonvolatile media, removable and non-removable media. Computer storage media may be implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 512.

It will be appreciated that FIG. 3 describes software that can act as an intermediary between users and computer resources. This software may include an operating system 528 which can be stored on disk storage 524, and which can control and allocate resources of the computer system 512. Disk storage 524 may be a hard disk drive connected to the system bus 518 through a non-removable memory interface such as interface 526. System applications 530 take advantage of the management of resources by operating system 528 through program modules 532 and program data 534 stored either in system memory 516 or on disk storage 524. It will be appreciated that computers can be implemented with various operating systems or combinations of operating systems.

A user can enter commands or information into the computer 512 through an input device(s) 536. Input devices 536 include but are not limited to a pointing device such as a mouse, trackball, stylus, touch pad, keyboard, microphone, and the like. These and other input devices connect to the processing unit 514 through the system bus 518 via interface port(s) 538. An interface port(s) 538 may represent a serial port, parallel port, universal serial bus (USB) and the like. Output devices(s) 540 may use the same type of ports as do the input devices. Output adapter 542 is provided to illustrate that there are some output devices 540 like monitors, speakers and printers that require particular adapters. Output adapters 542 include but are not limited to video and sound cards that provide a connection between the output device 540 and the system bus 518. Other devices and/or systems or devices such as remote computer(s) 544 may provide both input and output capabilities.

Computer 512 can operate in a networked environment using logical connections to one or more remote computers, such as a remote computer(s) 544. The remote computer 544 can be a personal computer, a server, a router, a network PC, a peer device or other common network node, and typically includes many or all of the elements described above relative to the computer 512, although only a memory storage device 546 has been illustrated in FIG. 4. Remote computer(s) 544 can be logically connected via communication connection 550. Network interface 548 encompasses communication networks such as local area networks (LANs) and wide area networks (WANs) but may also include other networks. Communication connection(s) 550 refers to the hardware/software employed to connect the network interface 548 to the bus 518. Connection 550 may be internal to or external to computer 512 and include internal and external technologies such as modems (telephone, cable, DSL and wireless) and ISDN adapters, Ethernet cards and so on.

It will be appreciated that the network connections shown are examples only and other means of establishing a communications link between the computers may be used. One of ordinary skill in the art can appreciate that a computer 512 or other client device can be deployed as part of a computer network. In this regard, the subject matter disclosed herein man pertain to any computer system having any number of memory or storage units, and any number of applications and processes occurring across any number of storage units or volumes. Aspects of the subject matter disclosed herein may apply to an environment with server computers and client computers deployed in a network environment, having remote or local storage. Aspects of the subject matter disclosed herein may also apply to a standalone computing device, having programming language functionality, interpretation and execution capabilities.

FIG. 4 illustrates an integrated development environment (IDE) 600 and Common Language Runtime Environment 602. An IDE 600 may allow a user (e.g., developer, programmer, designer, coder, etc.) to design, code, compile, test, run, edit, debug or build a program, set of programs, web sites, web applications, and web services in a computer system. Software programs can include source code (component 610), created in one or more source code languages (e.g., Visual Basic, Visual J#, C++. C#, J#, Java Script, APL, COBOL, Pascal, Eiffel, Haskell, ML, Oberon, Perl, Python, Scheme, Smalltalk and the like). The IDE 600 may provide a native code development environment or may provide a managed code development that runs on a virtual machine or may provide a combination thereof. The IDE 600 may provide a managed code development environment using the .NET framework. An intermediate language component 650 may be created from the source code component 610 and the native code component 611 using a language specific source compiler 620 and the native code component 611 (e.g., machine executable instructions) is created from the intermediate language component 650 using the intermediate language compiler 660 (e.g. just-in-time (JIT) compiler), when the application is executed. That is, when an IL application is executed, it is compiled while being executed into the appropriate machine language for the platform it is being executed on, thereby making code portable across several platforms. Alternatively, in other embodiments, programs may be compiled to native code machine language (not shown) appropriate for its intended platform.

A user can create and/or edit the source code component according to known software programming techniques and the specific logical and syntactical rules associated with a particular source language via a user interface 640 and a source code editor 651 in the IDE 600. Thereafter, the source code component 610 can be compiled via a source compiler 620, whereby an intermediate language representation of the program may be created, such as assembly 630. The assembly 630 may comprise the intermediate language component 650 and metadata 642. Application designs may be able to be validated before deployment.

The various techniques described herein may be implemented in connection with hardware or software or, where appropriate, with a combination of both. Thus, the methods and apparatus described herein, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing aspects of the subject matter disclosed herein. In the case of program code execution on programmable computers, the computing device will generally include a processor, a storage medium readable by the processor (including volatile and non-volatile memory and/or storage elements), at least one input device, and at least one output device. One or more programs that may utilize the creation and/or implementation of domain-specific programming models aspects, e.g., through the use of a data processing API or the like, may be implemented in a high level procedural or object oriented programming language to communicate with a computer system. However, the program(s) can be implemented in assembly or machine language, if desired. In any case, the language may be a compiled or interpreted language, and combined with hardware implementations.

While the subject matter disclosed herein has been described in connection with the figures, it is to be understood that modifications may be made to perform the same functions in different ways.

What is claimed:

1. A system comprising:
a processor and a memory including an IDE extension module, wherein the IDE extension module is a portion of an IDE, wherein an extension point comprises an element of a UI of the IDE, the IDE extension module extending the IDE, wherein the IDE extension module is configured to cause the processor to:
extend the IDE by receiving a user selection of the element of a plurality of elements in the IDE, determining a context of the user selection, back-mapping the context of the user selection to a wizard, a set of default settings or to source code and generating a new or modified IDE element in the IDE.

2. The system of claim 1, wherein the IDE extension module comprises a UI reflector and an IDE extension code generator.

3. The system of claim 2, wherein the UI reflector maps the context of the user selection to a form element, a class of data provider, a class, a subclass, a set of defaults for the element, a wizard to create the element or to source code for the element.

4. The system of claim 3, wherein the IDE extension module further comprises an IDE extension library comprising new or modified IDE elements extending the IDE.

5. The system of claim 4, wherein the IDE extension library comprises source code, IDE-generated code or data templates.

6. The system of claim 1, wherein the new or modified IDE element comprises one of: a tool window, an editor window, a menu item, a command bar item, a right click menu, an adornment of an editor, a margin of an editor, a classification of an editor, context-sensitive help, parameter help or quick help.

7. The system of claim 1, wherein the modified IDE element comprises an aggregating IDE element to which an additional data source is added.

8. A method comprising:
receiving a user selection of an IDE element within an IDE executing on a software development computer;
determining a context associated with the received user selection;
back-mapping the determined context to a corresponding wizard, set of defaults, source code or IDE-generated code for the IDE element;
generating a new or modified IDE element, the new or modified IDE element comprising an extension to the IDE, wherein the IDE is extended from an entry point comprising an element of a user interface of the IDE without using an SDK; and
incorporating the new or modified IDE element into the IDE.

9. The method of claim 8, wherein the new or modified IDE element is incorporated into a test IDE.

10. The method of claim 9, wherein the new or modified IDE element comprises one of: a tool window, an editor window, an aggregating element of the IDE, a menu item, a command bar item, a right click menu, an adornment of an editor, a margin of an editor, a classification of an editor, context-sensitive help, parameter help or quick help.

11. The method of claim 10, wherein back-mapping comprises mapping a cursor location to an underlying form element and via reflection, mapping the form element to a class of data provider.

12. The method of claim 10, wherein back-mapping comprises providing metadata linking a class to an expression of the class in a UI of the IDE.

13. The method of claim 10, wherein back-mapping comprises mapping the context associated with the user selection to context-specific code.

14. The method of claim 13, wherein the new or modified element of the IDE is stored in an IDE extension library, wherein the IDE extension library provides an indexing functionality for third party extension elements.

15. A computer-readable storage medium comprising computer-executable instructions which when executed cause at least one processor to:
receive a user selection of an IDE element within an IDE executing on a software development computer;
determine a context associated with the received user selection from a location from which the user selection was received;
back-map the determined context to a corresponding wizard, set of defaults or source code for the IDE element;
generate a new or modified IDE element; and
incorporate the new or modified IDE element into the IDE.

16. The computer-readable storage medium of claim 15, comprising further computer-executable instructions, which when executed cause the at least one processor to:
generate a test instance of the IDE, wherein the test instance of the IDE includes the new or modified IDE element.

17. The computer-readable storage medium of claim 15, comprising further computer-executable instructions, which when executed cause the at least one processor to:
generate an extension to the IDE, wherein the extension comprises a tool window, an editor window, an aggregating element of the editor window, a menu item, a command bar item, a right click menu, an adornment of an editor, a margin of an editor, a classification of an editor, context-sensitive help, parameter help or quick help.

18. The computer-readable storage medium of claim 15, comprising further computer-executable instructions, which when executed cause the at least one processor to:
back-map the determined context by mapping a cursor location of the user selection to an underlying form element and via reflection, mapping the underlying form element to a corresponding class.

19. The computer-readable storage medium of claim 15, comprising further computer-executable instructions, which when executed cause the at least one processor to:
transform an element of a plurality of elements of the IDE into an extension of the IDE via visual reflection, the visual reflection performed without use of an SDK.

20. The computer-readable storage medium of claim 19, comprising further computer-executable instructions, which when executed cause the at least one processor to:
create an extension to the IDE, the extension comprising one of tool window, an editor window, an aggregating element of the IDE, a menu item, a command bar item, a right click menu, an adornment of an editor, a margin of an editor, a classification of an editor, context-sensitive help, parameter help or quick help.
